(19) United States
(12) Patent Application Publication
(10) Pub. No.: US 2003/0065802 A1
(43) Pub. Date: Apr. 3, 2003

(54) System and method for dynamically producing a multimedia content sample for mobile terminal preview

(75) Inventors: Timo Vitikainen, Espoo (FI); Mauri Vaananen, Tampere (FI); Timo Syrjamaki, Lempaala (FI)

Correspondence Address: STEVEN R. FUNK, CRAWFORD PLLC, 1270 NORTHLAND DRIVE, SUITE 390, ST. PAUL,, MN, 55120, US

(73) Assignee: Nokia Corporation, Espoo (FI)

(21) Appl. No.: 09/967,244

(22) Filed: Sep. 28, 2001

(51) Int. Cl. G06F 15/16

(52) U.S. Cl. 709/231

(57) ABSTRACT

A system and method for dynamically creating a sample of multimedia content for preview by a user of a mobile terminal involves providing a first set of parameters associated with a size of a preview sample of the multimedia content, and providing a second set of parameters associated with composition of the preview sample. A preview sample is dynamically extracted from the multimedia content using the respective first and second parameter sets. A mobile terminal specific preview sample of the multimedia content is generated using the extracted preview sample for transmission to a specific mobile terminal.

### FIELD OF THE INVENTION

The present invention relates generally to network communications systems, and more particularly, to a system and method for providing a dynamically created preview sample of multimedia content for presentation at a mobile terminal.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. The proliferation of local, regional, and global networks, such as the Internet, has made available to users a vast sea of information. These networking technologies have expanded to increasingly include wireless and mobile technologies. Through these networks, information can be downloaded to desktop systems, wireless systems, mobile systems, etc. For example, information available via the Internet can now be downloaded onto mobile wireless units, such as cellular telephones, personal digital assistants (PDAs), laptop computers, etc.

One such technology facilitating the transfer of Internet content to and from wireless devices is the Wireless Application Protocol (WAP), which integrates the Internet and other networks with wireless network platforms. Generally, WAP is a set of protocols that accounts for characteristics and functionality of both Internet standards and standards for wireless services. It is independent of wireless network standards, and is designed as an open standard. WAP bridges the gap between the wireline Internet paradigm and the wireless domain, which allows wireless device users to enjoy the benefits of the Internet across both platforms.

Second generation wireless service, often referred to as 2G wireless service, is a current wireless service based on circuit-switched technology. 2G systems, such as Global System for Mobile communications (GSM) and Personal Communications Services (PCS), use digital radio technology for improved quality and a broader range of services over first generation mobile technologies. 3G, or third generation, refers to a set of digital technologies that promises improvements in capacity, speed, and efficiency by deploying new packet-based transmission methodologies between terminals and the network. Users of 3G devices and networks will have access to multimedia services such as video-on-demand, video conferencing, fast WEB access and file transfer.

The demand for multimedia content dissemination vis-à-vis mobile wireless communications is increasing. In general, it is relatively expensive and/or time consuming to transport large multimedia content files over mobile connections for purposes of determining the nature of the multimedia content or whether or not to download or purchase the multimedia content. Previewing of multimedia content is presently not supported in WAP or MMS (Multimedia Message Server) services. Moreover, conventional techniques that may be adapted to support a previewing function, such as low bit rate streaming over the Internet, do not deliver multimedia content at a sufficient level of quality, typically due to bandwidth constraints.

There is a need in the communications industry for a system and method for providing a multimedia previewing capability for mobile terminals. There exists a further need for such a system and method that provides high quality multimedia previewing that is optimized for a given mobile terminal. The present invention provides a solution to these and other shortcomings of the prior art, and offers additional advantages over the prior art.

### SUMMARY OF THE INVENTION

The present invention is directed to a system and method for dynamically creating a sample of multimedia content for preview by a user of a mobile terminal. A method according to the present invention involves providing a first set of parameters associated with a size of a preview sample of the multimedia content, and providing a second set of parameters associated with composition of the preview sample. The method further involves dynamically extracting the preview sample from the multimedia content using the respective first and second parameter sets, and generating a mobile terminal specific preview sample of the multimedia content using the extracted preview sample for transmission to a specific mobile terminal.

The first set of parameters can include one of a maximum downloading time parameter or a maximum downloading cost parameter, and the second set of parameters can include at least one composition rule associated with a composition of the preview sample of the multimedia content. The first set of parameters can also include a bit rate value associated with transmission of the extracted preview sample to the specific mobile terminal, and the second set of parameters can include a parameter indicative of a multimedia capability of the specific mobile terminal. The bit rate value can define an actual transmission bit rate value or an estimated transmission bit rate value.

Further, the first set of parameters can include a bit rate value associated with transmission of the extracted preview sample to the specific mobile terminal, and the second set of parameters can include at least one composition rule associated with a composition of the preview sample of the multimedia content. Also, the first set of parameters can include one of a maximum downloading time parameter or a maximum downloading cost parameter, and the second set of parameters can include a parameter indicative of a multimedia capability of the specific mobile terminal.

In one particular embodiment, a first parameter of the first parameter set includes a maximum downloading time parameter or a maximum downloading cost parameter, and a second parameter of the first parameter set comprises a bit rate value. According to this embodiment, a first parameter of the second parameter set defines one or more composition rules, and a second parameter of the second parameter set includes a multimedia capability parameter associated with the specific mobile terminal.

In one configuration, at least one parameter of the first set of parameters is established by a provider of the multimedia content or a user of the specific mobile terminal, and at least one parameter of the second set of parameters is a network resource parameter. In another configuration, at least one parameter of the first set of parameters is a network resource parameter, and at least one parameter of the second set of parameters is established by a provider of the multimedia content. In one particular configuration, a first parameter of the first parameter set and a first parameter of the second parameter set are established by a provider of the multimedia content, and a second parameter of the first parameter set and a second parameter of the second parameter set are network resource parameters.

Generating the mobile terminal specific preview sample can involve formatting the extracted preview sample to comply with a format usable by the specific mobile terminal. Generating the mobile terminal specific preview sample can further involve packaging the extracted preview sample with predetermined usage or distribution rules.

Dynamically extracting the preview sample can involve extracting the preview sample having a particular length based on the respective first and second parameter sets. In another approach, dynamically extracting the preview sample involves extracting the preview sample defined between a starting index and an ending index of the multimedia content based on the respective first and second parameter sets.

In accordance with another embodiment of the present invention, a server system for dynamically creating a sample of multimedia content for preview by a user of a mobile terminal includes a profile database that stores one or both of mobile terminal profiles and user profiles. The system also includes a multimedia content source that provides multimedia content. A manager module of the system is coupled to the profile database and multimedia content source. The manager module accesses the profile database and a specific mobile terminal to obtain a first set of parameters associated with a size of a preview sample of the multimedia content and a second set of parameters associated with composition of the preview sample. The manager module dynamically extracts the preview sample from the multimedia content using the respective first and second parameter sets, and generates a mobile terminal specific preview sample of the multimedia content using the extracted preview sample for transmission to the specific mobile terminal.

The manager module dynamically extracts the preview sample having a particular length based on the respective first and second parameter sets. Alternatively, the manager module dynamically extracts the preview sample defined between a starting index and an ending index of the multimedia content based on the respective first and second parameter sets.

The system may further include a packaging module coupled to the manager module. The packaging module formats the extracted preview sample to comply with a format usable by the specific mobile terminal. A rights management module may also be coupled to the manager module. The rights management module packages the extracted preview sample with predetermined usage or distribution rules.

In one configuration, the system includes a web server. In another configuration, the system includes a content gateway. In one particular configuration, the system supports a multimedia messaging service (MMS).

According to a further embodiment of the present invention, a method of wirelessly previewing multimedia content by a user involves transmitting a preview signal between a specific mobile terminal and a server system that provides multimedia content. The method involves accessing a first set of parameters associated with a size of a preview sample of the multimedia content and a second set of parameters associated with composition of the preview sample. A customized preview sample of the multimedia content is dynamically generated for the specific mobile terminal using the respective first and second parameter sets. The customized preview sample is transmitted to the specific mobile terminal, and the customized preview sample is played back at the specific mobile terminal.

The preview signal, in one configuration, is transmitted by the specific mobile terminal. For example, the preview signal can be generated by the specific mobile terminal operating in a browse mode. In another configuration, the preview signal is transmitted by the server system. For example, the preview signal can be generated by the server system implementing a push application. The customized preview sample can be formatted to comply with a format usable by the specific mobile terminal. The customized preview sample can also be packaged with predetermined usage or distribution rules.

The method may further involve selecting the multimedia content associated with the preview sample for downloading, and downloading the associated multimedia content to the specific mobile terminal. Playing the customized preview sample can involve automatically launching a media playing facility of the specific mobile terminal. The user can be charged for downloading the associated multimedia content to the specific mobile terminal.

In accordance with yet another embodiment of the present invention, a system for facilitating wireless previewing of multimedia content by a user includes a mobile terminal, a profile database that stores one or both of mobile terminal profiles and user profiles, a multimedia content source that provides multimedia content, and a manager module communicatively coupled to the profile database, multimedia content source, and mobile terminal.

The manager module, in response to a preview signal communicated between the mobile terminal and the manager module, accesses the profile database and the mobile terminal to obtain a first set of parameters associated with a size of a preview sample of the multimedia content and a second set of parameters associated with composition of the preview sample. The manager module dynamically generates a customized preview sample of the multimedia content for the mobile terminal using the respective first and second parameter sets, and transmits the customized preview sample to the mobile terminal for playback by the mobile terminal.

The preview signal, in one system configuration, is transmitted by the mobile terminal. For example, the preview signal can be generated by the mobile terminal operating in a browse mode. In another system configuration, the preview signal is transmitted by the manager module. For example, the preview signal can be generated by the manager module implementing a push application.

After previewing the customized preview sample, the mobile terminal can transmit a download signal, and the manager module can download multimedia content associated with the customized preview sample to the mobile terminal in response to the download signal. The mobile terminal can automatically launch a media playing facility to playback the customized preview sample. The manager module can account for use charges accrued by the user for downloading the associated multimedia content to the mobile terminal.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a block diagram of a system for providing a dynamically created preview sample of multimedia content for presentation at a mobile terminal in accordance with an embodiment of the present invention;

FIG. 2 is a flow diagram showing several processes involving the creation and delivery of a multimedia preview sample in accordance with an embodiment of the present invention;

FIG. 3 illustrates several processes involving the creation and delivery of a multimedia preview sample in accordance with a further embodiment of the present invention;

FIG. 4 is a chart that provides various parameters that influence the process of extracting a multimedia preview sample according to an embodiment of the present invention;

FIG. 5 illustrates a WEB server environment within which a dynamic multimedia previewing system and method of the present invention may be practiced; and

FIG. 6 illustrates an MMS push environment within which a dynamic multimedia previewing system and method of the present invention may be practiced.

While the invention is amenable to various modifications and alternative forms, specifics thereof have been shown by way of example in the drawings and will be described in detail hereinbelow. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION OF VARIOUS EMBODIMENTS

In the following description of the various embodiments, reference is made to the accompanying drawings which form a part hereof, and in which is shown by way of illustration various embodiments in which the invention may be practiced. It is to be understood that other embodiments may be utilized, and structural and functional modifications may be made without departing from the scope of the present invention.

The present invention is directed to a system and method for automatically and adaptively creating a preview sample of multimedia content for presentation at a mobile terminal. A preview sample, for example, is prepared by automatically and dynamically extracting the preview sample from the subject multimedia content and delivering the preview sample over a mobile network to a user of a mobile terminal. The preview sample is preferably an optimized sample of the subject multimedia content.

An extract of the subject multimedia content may be optimized in terms of one or more of duration, position within a media program track, quality, level of compression, and user or service/content provider preferences, for example. Optimization of the preview sample extract may further be influenced by several time-varying (e.g., dynamic) parameters, such as network condition, changing user or service/content provider preferences, and mobile terminal capabilities. The preview sample may further be processed to comply with a format appropriate for a given mobile terminal, and may also be packaged with security or other usage or distribution rights. The present invention thus provides for a preview sample of multimedia content that is dynamically created for presentation on a specific mobile terminal based on a number of pre-defined and dynamic factors.

Accessing multimedia content in mobile networks can be expensive and/or time consuming, since the amount of data associated with multimedia content transmission is relatively high. Often, it is not necessary or desired to access the full content of a multimedia program/message. Rather, a mobile terminal user may only wish to preview a relatively small sample of the subject multimedia program/message. After previewing a sample of a selected multimedia program/message, the user can choose to discard the preview sample if uninterested, store the preview sample for future access and consideration, or purchase the full program/message for immediate or subsequent downloading to the mobile terminal. The mobile aware adaptive preview capability of the present invention provides a balance between a user's subjective experience (attractive/information), usability (downloading time represents waiting time for the user), and cost (downloading costs to user or service/content provider).

Implementing a dynamic multimedia previewing system and method in accordance with the principles of the present invention provides for several advantages, including obviating the need to maintain additional pre-composed multimedia content for previewing purposes. Conventional approaches, for example, typically provide pre-composed preview clips prepared in a certain format. The sample content selection, size, and format of the pre-composed preview clips may not be compatible for a given mobile terminal. Even if compatibility was not at issue, pre-composed preview clips are static in nature, and are not sufficiently flexible in terms of content selection, size, and format for the dynamically changing mobile network conditions and variety in mobile terminal capabilities. Selecting the extract, size, and (optionally) delivery format adaptively according to a given user's needs makes it possible to both optimize user experience and reduce the cost of previewing.

Moreover, implementing a dynamic multimedia previewing system and method of the present invention requires no additional features for a mobile terminal that provides a multimedia browsing capability. Another advantage includes obviating the need for expensive hardware and/or software for circuit-switched connectivity, as is typically the case in current mobile preview solutions for audio/voice content.

Previewing of audio content over a circuit-switched connection is typically expensive, and the sound quality in current cellular systems is not sufficient for audio/music content. A dynamic multimedia previewing system and method of the present invention supports quality audio/music content transmission and previewing. No appreciable reduction in audio quality is incurred, as is typically the case when previewing audio content over circuit-switched (e.g., voice codec) connections or streaming connections. Also, mobile previewing of multimedia content in accordance with the principles of the present invention may be supported in WAP or MMS services. In general, a dynamic multimedia previewing system and method of the present invention supports true mobile multimedia content business applications where content is browsed, pushed, previewed, ordered/paid for, and/or consumed using a mobile terminal.

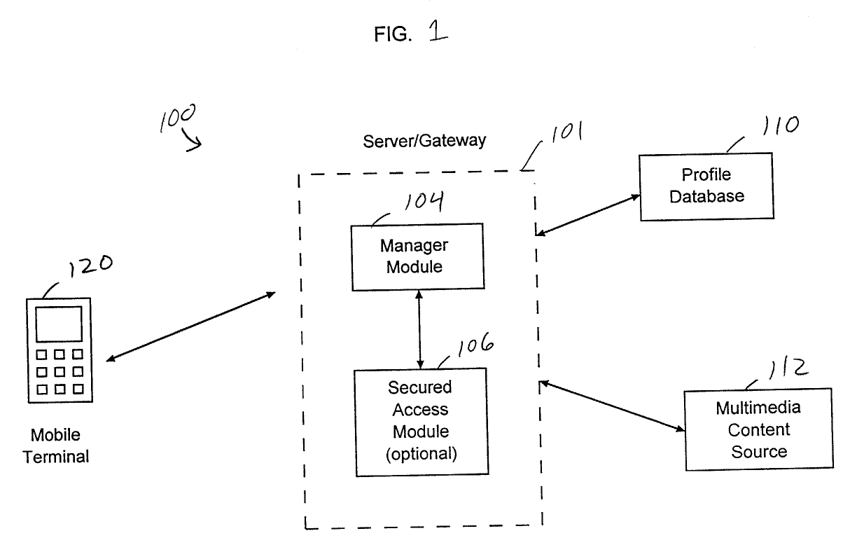

Turning now to the figures, and more particularly to FIG. 1, there is illustrated a block diagram of a system 100 for providing a dynamically created preview sample of multimedia content for presentation at a mobile terminal in accordance with an embodiment of the present invention. The system 100 is shown to include a content server or gateway 101 which communicates with a mobile terminal 120. In this configuration, voice, data, audio, motion video, visual, music, and other multimedia information and content is communicated between the sever/gateway 101 and mobile terminal 120. In addition, and as will be discussed in detail hereinbelow, the server/gateway 101 provides for the generation of a preview sample in accordance with the present invention which is delivered to the mobile terminal 120 via a mobile network.

The server/gateway 101 includes a manager module 104 which is coupled to a profile database 110 and a multimedia content source 112. The profile database 110 typically stores profile information concerning subscribers and mobile terminals of the subscribers. A typical mobile terminal profile, for example, includes information concerning the multimedia capabilities of a given mobile terminal. The multimedia content source 112 provides archival and real-time multimedia content, which may be made available to the mobile terminal 120 via the server/gateway 101. The multimedia content source may, for example, provide storage for a diverse variety of multimedia content, such as audio, motion video, visual, and music programming, and combinations of these and other multimedia content types. The multimedia content source 112 may also provide live or quasi-live feed from a content provider, such as a broadcaster of news, entertainment, and the like. Accordingly, the multimedia content source 112 can provide both pre-produced and live multimedia content to the server/gateway 101.

In general, the manager module 104 coordinates the activities of the server/gateway 101 and the interaction with the profile database 110 and multimedia content source 112. The manager module 104 also coordinates communications between the server/gateway 101 and the mobile terminal 120. The manager module 104 obtains information from both the mobile terminal 120 and the profile database 110 when dynamically creating a preview sample extracted from a selected multimedia program or message provided by the multimedia content source 112 for transmission to a specific mobile terminal 120. In one embodiment, the manager module 104 cooperates with a secured access module 106 to package the multimedia preview sample with access, usage, and/or distribution rights.

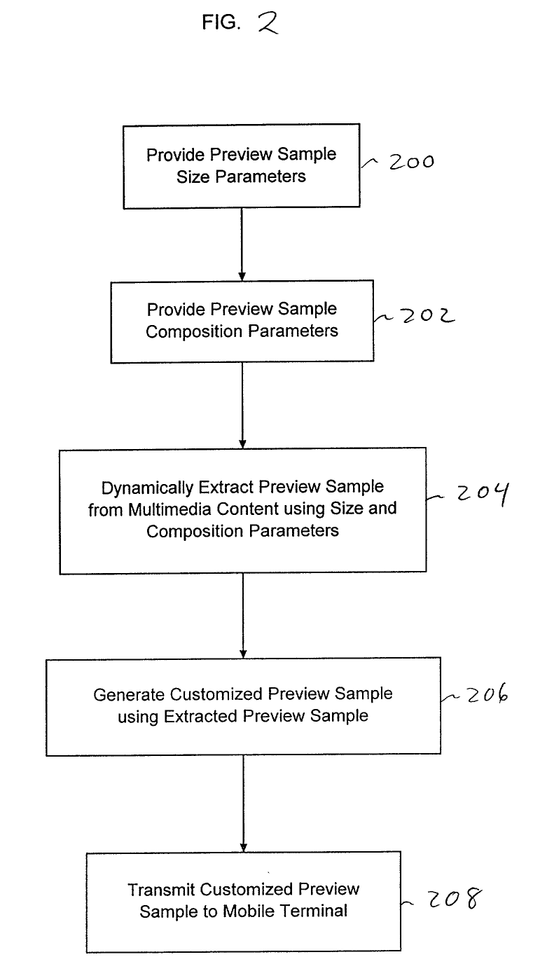

In FIG. 2, there is illustrated in flow diagram form several processes involving the creation and delivery of a multimedia preview sample in accordance with an embodiment of the present invention. According to this embodiment, one or more size parameters associated with a multimedia preview sample to be created are provided 200. One or more parameters concerning the composition of the multimedia preview sample are also provided 202. Using the size and composition parameters, a preview sample is dynamically extracted 204 from the subject multimedia content. A customized preview sample is generated 206 using the extracted preview sample. The customized preview sample may represent a formatted version of the extracted preview sample appropriate for a given mobile terminal, and may further include usage or distribution rights (i.e., rules limiting usage and/or distribution). The customized preview sample is transmitted 208 to the mobile terminal for previewing by the user.

According to one implementation, and with continued reference to FIG. 1, the manager module 104 accesses the profile database 110 and the requesting mobile terminal 120 to obtain a first set of parameters associated with a size of a preview sample to be produced. The manager module 104 also accesses the profile database 110 and the requesting mobile terminal 120 to obtain a second set of parameters associated with the composition of the preview sample to be produced. Using the respective first and second parameter sets, the manager module 104 adaptively extracts the preview sample from the multimedia content and generates a terminal specific preview sample of the multimedia content using the extracted preview sample. The terminal specific preview sample is then transmitted to the mobile terminal 120 for previewing by the user.

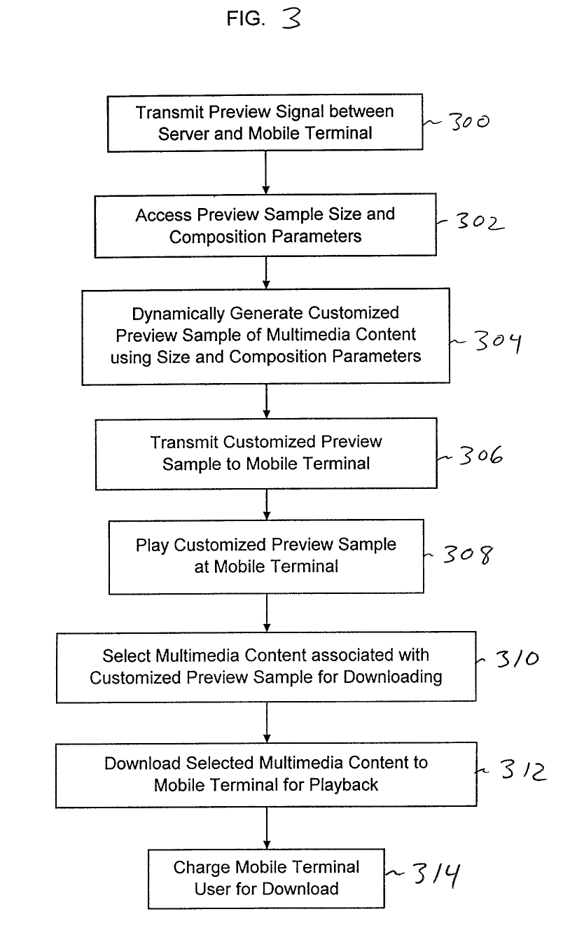

FIG. 3 illustrates several processes involving the creation and delivery of a multimedia preview sample in accordance with a further embodiment of the present invention. According to one approach, referred to herein as a browsing approach, the mobile terminal 120 transmits 300 a preview signal to the manager module 104 to initiate generation of a multimedia preview sample. According to another approach, referred to herein as a messaging service push (e.g., Multimedia Message Server (MMS) push) approach, a messaging service delivers 300 a preview notification to a user's mobile terminal 120. As such, a preview signal or message, which can take many forms, can be produced by the mobile terminal 120 and transmitted to the server/gateway 101. Alternatively, the preview signal can be produced by the server/gateway 101 and transmitted to the mobile terminal 120.

Upon receiving a preview request signal from the mobile terminal 120, the manager module 104 accesses 302 size and composition parameters associated with the multimedia preview sample to be generated. Typically, the size and composition parameters include both pre-defined and dynamically determined parameters that govern the preview sample extraction process. The manager module 104 dynamically generates 304 a customized preview sample of the user or server selected multimedia content using the size and composition parameters. The manager module 104 coordinates transmission 306 of the customized preview sample from the server/gateway 101 to the mobile terminal 120.

In one approach, a media playback resource of the mobile terminal 120 is automatically launched when the mobile terminal 120 receives the customized preview sample. Alternatively, the user may be notified that the preview sample is ready for presentation via an aural, visual, or tactile indicator. The customized preview sample is played 308 at the mobile terminal 120. If the user does not wish to view the full or additional multimedia content associated with customized preview sample, the sample may be discarded (e.g., deleted from memory). The user may alternatively store the preview sample for subsequent playback and consideration. The user may also select 310 all or a portion of the multimedia content associated with the customized preview sample for downloading to the mobile terminal 120.

The selected multimedia content can then be downloaded 312 to the mobile terminal 120 for immediate or subsequent playback by the user. If the provider of the multimedia content charges a fee for the downloaded content (e.g., the content is not the user's personal content or free content), a charge is accrued 314 to the user's account for the download. The fees attributed to a particular mobile terminal 120 may be stored in the user's (subscriber's) profile stored in the profile database 110.

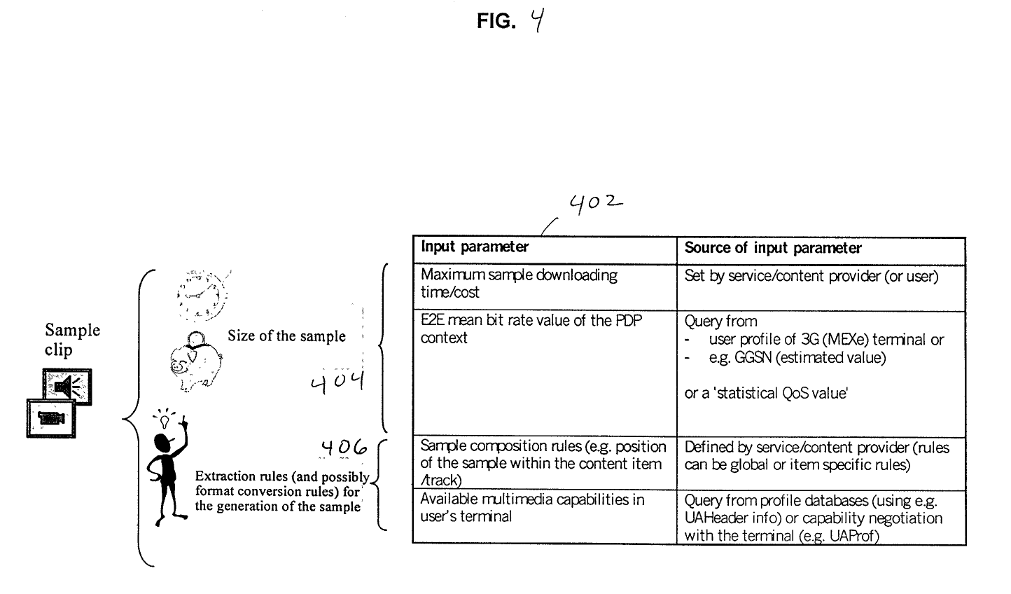

FIG. 4 is a chart that provides various parameters 402 that influence the process of extracting a multimedia preview sample according to an embodiment of the present invention. The parameters described in FIG. 4 are representative of various factors that govern the extraction and optimization processes associated with a multimedia preview sample produced for transmission to, and playback by, a specific mobile terminal. The parameters impacting multimedia preview sample production include one or more pre-defined parameters and one or more dynamically assessed parameters. The acquisition and use of such parameters, particularly the dynamic parameters, provides for the production of a multimedia preview sample that is optimized and customized for a particular requesting mobile terminal.

The parameters described in FIG. 4 include pre-defined and dynamic parameters that influence the size and composition of the multimedia preview sample to be generated. In the particular embodiment shown in FIG. 4, a first set of parameters 404 impacts the size of the multimedia preview sample, while a second set of parameters 406 impacts the composition of the multimedia preview sample. Each of the first and second sets of parameters in this non-limiting illustrative example includes a pre-defined parameter and a dynamic parameter.

The first set of parameters 404 impacting the size of the multimedia preview sample includes a maximum downloading cost parameter. Alternatively, or in addition, the downloading parameter may be expressed as a maximum downloading time parameter. These pre-defined costtime parameters are typically set by the service/content provider or the mobile terminal user.

The first set of parameters 404 also includes a bit rate value, which is considered a dynamic parameter. In general, the optimal size of a multimedia preview sample can be determined in part, or entirely, using the bit rate value that affects downloading time between the server/gateway and the mobile terminal. In one embodiment, the optimal size of the multimedia preview sample can be determined using the bit rate value of the PDP context, which is a logical connection between the mobile terminal and the gateway. The bit rate value, which affects downloading time, is considered a more important or sensitive parameter for usability in the browsing approach than in the messaging service push approach.

A useful value to use for optimizing the size of the multimedia preview sample is the E2E (end-to-end QoS) mean value. The E2E mean value can be queried from the user profile (API) of a 3G (3^{rd} generation) mobile terminal, such as a MEXe (Mobile Station Application Execution Environment (GSM 02.57)) terminal. It is noted that MEXe defines a framework to ensure a predictable environment for third-party applications in GSM or UMTS mobile terminals. MEXe does this by defining different technology requirements called, referred to as “classmarks.” MEXe classmark 1, for example, is based on WAP, and classmark 2 is based on PersonalJava and JavaPhone. Other classmarks may be defined in future MEXe specifications. MEXe specifies additional requirements for all classmarks, for instance a security environment, capability and content negotiation, a user profile, user interface personalization, management of services and virtual home environment. A MEXe mobile terminal can support any number of classmarks.

If the E2E mean value is not available or cannot be queried, then an estimated bit rate value can be used, such as a statistical QoS (Quality of Service) value. By way of example, the estimated bit rate value may be queried from a GGSN (Gateway GPRS Support Node). A GGSN acts as a gateway between a GPRS (General Packet Radio System) mobile communications network and a packet-switched public data network. A GPRS mobile communications network is a packet-switched service for Global System for Mobile Communications (GSM) that mirrors the Internet model and Enables seamless transition towards 3G networks. GPRS provides actual packet radio access for mobile GSM and time-division multiple access (TDMA) users, and is ideal for WAP services. The GGSN allows mobile subscribers to access a public data network or specified private IP networks. The connection between the GGSN and the public data network is generally enabled through a standard protocol, such as the Internet Protocol (IP).

The second set of parameters 406 impacting the extraction of the multimedia preview sample includes composition rules, which are considered pre-defined parameters. Composition rules are typically defined by the service/content provider. The composition rules can be global or item specific in terms of application. A composition rule, by way of example, may specify the position of the preview sample within the subject multimedia content item or track. The composition rules may define a starting index and an ending index of the subject multimedia content, such that the preview sample represents a portion of the subject multimedia content extracted between the starting and ending indices.

The second set of parameters 406 also includes a multimedia capability parameter, which is considered a dynamic parameter. The capabilities of various mobile terminals to play/view multimedia preview clips (i.e., samples) may differ significantly. As such, the multimedia capabilities of a specific mobile terminal have to be determined in order to adapt and transfer a multimedia preview clip to a subscriber. The multimedia capabilities of a specific mobile terminal may be queried from a profile database or from negotiation with the mobile terminal.

When a subscriber requests a multimedia preview sample from a WEB server, for example, information about the requesting mobile server is also provided through the User Agent Header field (UAHeader) of the WSP (Wireless Service Provider) session. Available multimedia capabilities of the mobile terminal may also be determined through capability negotiation with the mobile terminal. For example, if the mobile terminal supports WAP UAProf (User Agent Profile), the mobile terminal provides detailed information according to the UAProf specification.

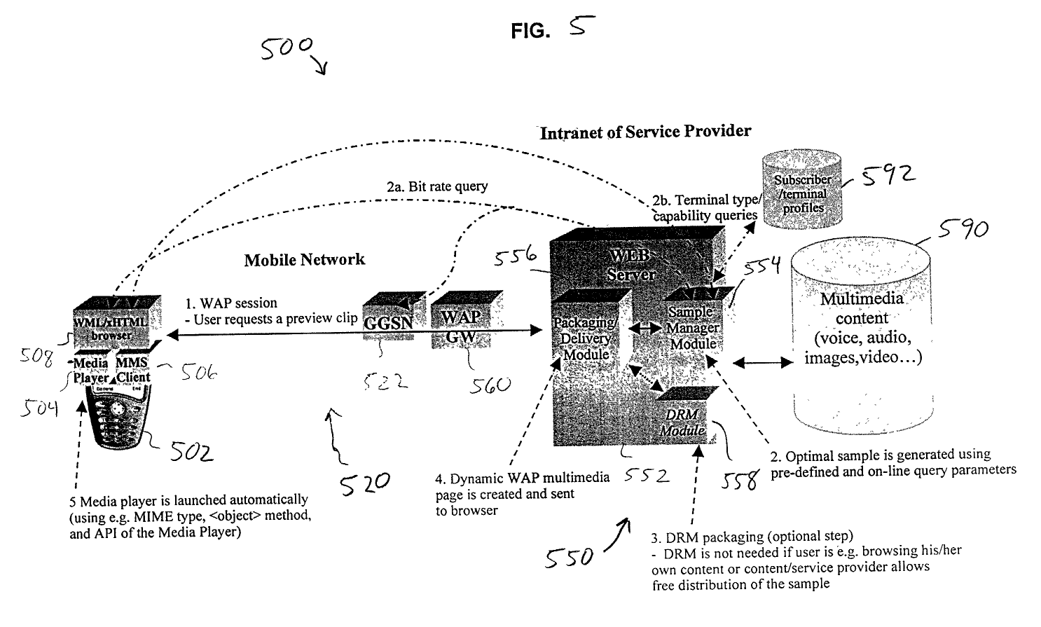

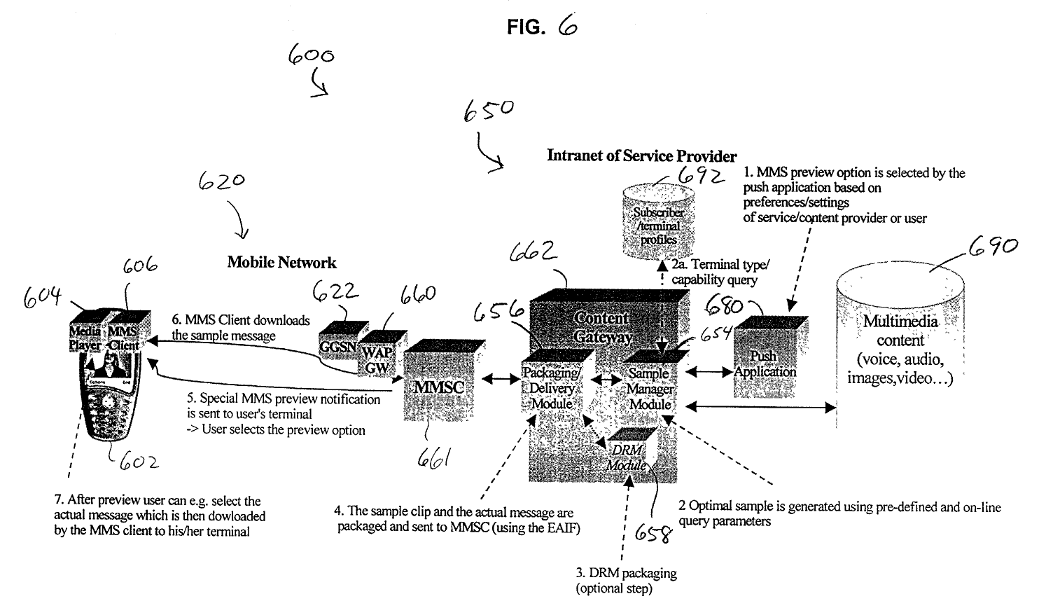

FIG. 5 illustrates a WEB server environment within which a dynamic multimedia previewing system and method of the present invention may be practiced. The system 500 shown in FIG. 5 is an exemplary system that supports browsing of multimedia content by a mobile terminal 502. The system 500 depicted in FIG. 5 includes an intranet 550 of a service provider, a mobile network 520, and a mobile terminal 502. It is noted that the modules and other elements shown in FIG. 5 and FIG. 6 are preferably implemented in software, but may be implemented in a combination of hardware and software.

The mobile terminal 502 preferably provides for browsing of multimedia content, such as voice, audio (music, ringing tones, etc.), images, and video. The mobile terminal 502 may, for example, employ a visual WAP (e.g., WML/xHTML) browser 508. As shown, the mobile terminal 502 includes a media player 504 and supports an MMS client 506. The mobile network 520 communicates with the service provider intranet 550 via a GGSN 522.

The service provider intranet 550 is shown to include a WEB server 552. The WEB server 552 includes a manager module 554, a packaging/delivery module 556, and a DRM (Digital Rights Management) module 558. The service provider intranet 550 further includes a WAP gateway 560, a subscriber/terminal profile database 592, and a multimedia content source 590.

In practice, a WAP session is initiated, during which a user requests a multimedia preview sample or clip using the mobile terminal 502. The user may, for example, browse a listing of multimedia programs and messages, select a particular program or message, and depress a preview button for the selected program or message. In response to the user request, the manager module 554 of the service provider intranet 550 communicates with the mobile terminal 502 and the subscriber/terminal profile database 592 to obtain various pre-defined and dynamic parameters used to the generate an optimal preview sample.

For example, the manager module 554 obtains predefined parameters including one or both of the maximum downloading time/cost and preview sample composition rules. The manager module 554 also obtains dynamic parameters including the bit rate value and multimedia capabilities of the user's specific mobile terminal 502 (e.g., available decoders). Having accessed the subject multimedia program or message from the multimedia content source 590, the manager module 554 generates an optimal preview sample using the pre-defined and dynamic parameters obtained from the mobile terminal 502 and the subscriber/terminal profile database 592.

The packaging/delivery module 556 handles packaging and delivery of the preview sample extracted by the manager module 554. The packaging/delivery module 556 may format the extracted preview sample using a format appropriate for the user's specific mobile terminal 502. As an optional procedure, the packaging/delivery module 556 calls the DRM module 558 for addition of appropriate usage rules, encryption of the preview samples, and packetization into a secure container. Delivery of the preview sample to the mobile terminal 502 via the WAP gateway 560 and GGSN 522 is preferably accomplished using clips, such as by over a WAP browsing session or using MMS, or by use of streaming in 3G AII-IP networks.

FIG. 6 illustrates an MMS push environment within which a dynamic multimedia previewing system and method of the present invention may be practiced. The system 600 shown in FIG. 6 is an exemplary system that supports a special MMS preview notification which is delivered to the user's mobile terminal 602. MMS preview notification preferably includes two downloading options: preview of the content/message and the actual content/message. Such a preview notification can be delivered to the user in the form of an invitation or offer to gain experience with the provider's content. Notification may also come in the form of special rules offered to the user relating to fee charging and digital rights management (DRM). For example, the actual content/message may be protected by DRM rules, but the preview sample can be freely distributed. Further, notification as to the size of the message exceeding a pre-defined value, such as a value indicating a noticeable downloading time/cost, may also be delivered.

The system 600 depicted in FIG. 6 includes an intranet 650 of a service provider, a mobile network 620, and a mobile terminal 602. The mobile terminal 602 according to this embodiment includes a media player 604 and supports an MMS client 606. The mobile network 620 communicates with the service provider intranet 650 via a GGSN 622.

The service provider intranet 650 is shown to include a content gateway 662. The content gateway 662 includes a manager module 654, a packaging/delivery module 656, a Multimedia Message Service Center (MMSC) 661, and a DRM module 658. The service provider intranet 650 further includes a WAP gateway 660, a subscriber/terminal profile database 692, a multimedia content source 690, and a push application 680.

In practice, an MMS preview option is selected by the push application 680 based on preferences and/or settings established by the service/content provider or the user. The user selects a preview option. Alternatively, the user may initiate a user requested push, such as by requesting certain content using SMS (Short Messaging Service) keywords, for example. The manager module 654 generates an optimal sample clip using pre-defined and dynamic parameters in a manner previously described. DRM packaging may optionally be performed by the DRM module 658. The sample preview clip and the actual message are packaged by the packaging/deliver module 656 and sent to the MMSC 661. A special MMS preview notification is sent to the user's mobile terminal 602 using a notification delivery method of the MMS.

After receipt of the special MMS preview notification by the mobile terminal 602, the user selects the preview option. The MMS client 606 downloads the sample preview message to the mobile terminal 602. The user may then play the sample preview message using the media player 604 of the mobile terminal 602. After previewing the sample preview message, the user may select the actual message which is subsequently downloaded by the MMS client 606 to the mobile terminal 602. A charge may be accrued to the user's account/profile for the download of the actual message or content.

While the invention is amenable to various modifications and alternative forms, specifics thereof have been shown by way of example in the drawings and will be described in detail hereinbelow. It is to be understood, however, that the intention is not to limit the invention to the particular embodiments described. On the contrary, the invention is intended to cover all modifications, equivalents, and alternatives falling within the scope of the invention as defined by the appended claims.

What is claimed is:

1. A method of dynamically creating a sample of multimedia content for preview by a user of a mobile terminal, comprising:
providing a first set of parameters associated with a size of a preview sample of the multimedia content;
providing a second set of parameters associated with composition of the preview sample;
dynamically extracting the preview sample from the multimedia content using the respective first and second parameter sets; and
generating a mobile terminal specific preview sample of the multimedia content using the extracted preview sample for transmission to a specific mobile terminal.

2. The method of claim 1, wherein the first set of parameters comprises one of a maximum downloading time parameter or a maximum downloading cost parameter, and the second set of parameters comprises at least one composition rule associated with a composition of the preview sample of the multimedia content.

3. The method of claim 1, wherein the first set of parameters comprises a bit rate value associated with transmission of the extracted preview sample to the specific mobile terminal, and the second set of parameters comprises a parameter indicative of a multimedia capability of the specific mobile terminal.

4. The method of claim 3, wherein the bit rate value defines an actual transmission bit rate value or an estimated transmission bit rate value.

5. The method of claim 1, wherein the first set of parameters comprises a bit rate value associated with transmission of the extracted preview sample to the specific mobile terminal, and the second set of parameters comprises at least one composition rule associated with a composition of the preview sample of the multimedia content.

6. The method of claim 1, wherein the first set of parameters comprises one of a maximum downloading time parameter or a maximum downloading cost parameter, and the second set of parameters comprises a parameter indicative of a multimedia capability of the specific mobile terminal.

7. The method of claim 6, wherein the bit rate value defines an actual transmission bit rate value or an estimated transmission bit rate value.

8. The method of claim 1, wherein:
a first parameter of the first parameter set comprises a maximum downloading time parameter or a maximum downloading cost parameter;
a second parameter of the first parameter set comprises a bit rate value;
a first parameter of the second parameter set defines one or more composition rules; and
a second parameter of the second parameter set comprises a multimedia capability parameter associated with the specific mobile terminal.

9. The method of claim 1, wherein at least one parameter of the first set of parameters is established by a provider of the multimedia content or a user of the specific mobile terminal, and at least one parameter of the second set of parameters is a network resource parameter.

10. The method of claim 1, wherein at least one parameter of the first set of parameters is a network resource parameter, and at least one parameter of the second set of parameters is established by a provider of the multimedia content.

11. The method of claim 1, wherein:
a first parameter of the first parameter set and a first parameter of the second parameter set are established by a provider of the multimedia content; and
a second parameter of the first parameter set and a second parameter of the second parameter set are network resource parameters.

12. The method of claim 1, wherein generating the mobile terminal specific preview sample further comprises formatting the extracted preview sample to comply with a format usable by the specific mobile terminal.

13. The method of claim 1, wherein generating the mobile terminal specific preview sample further comprises packaging the extracted preview sample with predetermined usage or distribution rules.

14. The method of claim 1, wherein dynamically extracting the preview sample comprises extracting the preview sample having a particular length based on the respective first and second parameter sets.

16. The method of claim 1, wherein dynamically extracting the preview sample comprises extracting the preview sample defined between a starting index and an ending index of the multimedia content based on the respective first and second parameter sets.

17. A server system for dynamically creating a sample of multimedia content for preview by a user of a mobile terminal, comprising:
a profile database that stores one or both of mobile terminal profiles and user profiles;
a multimedia content source that provides multimedia content; and
a manager module coupled to the profile database and multimedia content source, the manager module accessing the profile database and a specific mobile terminal to obtain a first set of parameters associated with a size of a preview sample of the multimedia content and a second set of parameters associated with composition of the preview sample, the manager module dynamically extracting the preview sample from the multimedia content using the respective first and second parameter sets, and generating a mobile terminal specific preview sample of the multimedia content using the extracted preview sample for transmission to the specific mobile terminal.

18. The system of claim 17, wherein the first set of parameters comprises one of a maximum downloading time parameter or a maximum downloading cost parameter, and the second set of parameters comprises at least one composition rule associated with a composition of the preview sample of the multimedia content.

19. The system of claim 17, wherein the first set of parameters comprises a bit rate value associated with transmission of the extracted preview sample to the specific mobile terminal, and the second set of parameters comprises a parameter indicative of a multimedia capability of the specific mobile terminal.

20. The system of claim 19, wherein the bit rate value defines an actual transmission bit rate value or an estimated transmission bit rate value.

21. The system of claim 17, wherein the first set of parameters comprises a bit rate value associated with transmission of the extracted preview sample to the specific mobile terminal, and the second set of parameters comprises at least one composition rule associated with a composition of the preview sample of the multimedia content.

22. The system of claim 17, wherein the first set of parameters comprises one of a maximum downloading time parameter or a maximum downloading cost parameter, and the second set of parameters comprises a parameter indicative of a multimedia capability of the specific mobile terminal.

23. The system of claim 22, wherein the bit rate value defines an actual transmission bit rate value or an estimated transmission bit rate value.

24. The system of claim 17, wherein:
a first parameter of the first parameter set comprises a maximum downloading time parameter or a maximum downloading cost parameter;
a second parameter of the first parameter set comprises a bit rate value;
a first parameter of the second parameter set defines one or more composition rules; and
a second parameter of the second parameter set comprises a multimedia capability parameter associated with the specific mobile terminal.

25. The system of claim 17, further comprising a packaging module coupled to the manager module, the packaging module formatting the extracted preview sample to comply with a format usable by the specific mobile terminal.

26. The system of claim 17, further comprising a rights management module coupled to the manager module, the rights management module packaging the extracted preview sample with predetermined usage or distribution rules.

27. The system of claim 17, wherein the manager module dynamically extracts the preview sample having a particular length based on the respective first and second parameter sets.

28. The system of claim 17, wherein the manager module dynamically extracts the preview sample defined between a starting index and an ending index of the multimedia content based on the respective first and second parameter sets.

29. The system of claim 17, wherein the system supports a multimedia messaging service (MMS).

30. The system of claim 17, wherein the system comprises a web server.

31. The system of claim 17, wherein the system comprises a content gateway.

32. A method of wirelessly previewing multimedia content by a user, comprising:
transmitting a preview signal between a specific mobile terminal and a server system that provides multimedia content;
accessing a first set of parameters associated with a size of a preview sample of the multimedia content and a second set of parameters associated with composition of the preview sample;
dynamically generating a customized preview sample of the multimedia content for the specific mobile terminal using the respective first and second parameter sets;
transmitting the customized preview sample to the specific mobile terminal; and
playing the customized preview sample at the specific mobile terminal.

33. The method of claim 32, wherein the preview signal is transmitted by the specific mobile terminal.

34. The method of claim 32, wherein the preview signal is generated by the specific mobile terminal operating in a browse mode.

35. The method of claim 32, wherein the preview signal is transmitted by the server system.

36. The method of claim 32, wherein the preview signal is generated by the server system implementing a push application.

37. The method of claim 32, wherein playing the customized preview sample further comprises automatically launching a media playing facility of the specific mobile terminal.

38. The method of claim 32, further comprising selecting the multimedia content associated with the preview sample for downloading, and downloading the associated multimedia content to the specific mobile terminal.

39. The method of claim 38, further comprising charging the user for downloading the associated multimedia content to the specific mobile terminal.

40. The method of claim 32, wherein the first set of parameters comprises one or more of a maximum downloading time parameter, a maximum downloading cost parameter, and a bit rate value associated with transmission of the customized preview sample to the specific mobile terminal, and the second set of parameters comprises at least one or more of a composition rule associated with a composition of the customized preview sample and a parameter indicative of a multimedia capability of the specific mobile terminal.

41. The method of claim 32, wherein generating the customized preview sample further comprises one or both of dynamically extracting the customized preview sample having a particular length based on the respective first and second parameter sets and dynamically extracting the customized preview sample defined between a starting index and an ending index of the multimedia content based on the respective first and second parameter sets.

42. The method of claim 32, wherein generating the customized preview sample further comprises formatting the customized preview sample to comply with a format usable by the specific mobile terminal.

43. The method of claim 32, wherein generating the customized preview sample further comprises packaging the customized preview sample with predetermined usage or distribution rules.

44. A system for facilitating wireless previewing of multimedia content by a user, comprising:
a mobile terminal;
a profile database that stores one or both of mobile terminal profiles and user profiles;
a multimedia content source that provides multimedia content; and
a manager module communicatively coupled to the profile database, multimedia content source, and mobile terminal, the manager module, in response to a preview signal communicated between the mobile terminal and the manager module, accessing the profile database and the mobile terminal to obtain a first set of parameters associated with a size of a preview sample of the multimedia content and a second set of parameters associated with composition of the preview sample, the manager module dynamically generating a customized preview sample of the multimedia content for the mobile terminal using the respective first and second parameter sets, and transmitting the customized preview sample to the mobile terminal for playback by the mobile terminal.

45. The system of claim 44, wherein the preview signal is transmitted by the mobile terminal.

46. The system of claim 44, wherein the preview signal is generated by the mobile terminal operating in a browse mode.

47. The system of claim 44, wherein the preview signal is transmitted by the manager module.

48. The system of claim 44, wherein the preview signal is generated by the manager module implementing a push application.

49. The system of claim 44, wherein the mobile terminal automatically launches a media playing facility to playback the customized preview sample.

50. The system of claim 44, wherein the mobile terminal transmits a download signal, and the manager module downloads multimedia content associated with the customized preview sample to the mobile terminal in response to the download signal.

51. The system of claim 50, wherein the manager module accounts for use charges accrued by the user for downloading the associated multimedia content to the mobile terminal.

52. The system of claim 44, wherein the manager module coordinates formatting of the customized preview sample to comply with a format usable by the mobile terminal.

53. The system of claim 44, wherein the manager module coordinates packaging of the customized preview sample with predetermined usage or distribution rules.

54. The system of claim 44, wherein the first set of parameters comprises one or more of a maximum downloading time parameter, a maximum downloading cost parameter, and a bit rate value associated with transmission of the customized preview sample to the customized mobile terminal, and the second set of parameters comprises at least one or more of a composition rule associated with a composition of the customized preview sample and a parameter indicative of a multimedia capability of the customized mobile terminal.

55. The system of claim 44, wherein the manager module coordinates dynamic extraction of the customized preview sample having a particular length based on the respective first and second parameter sets or coordinates dynamic extraction of the customized preview sample defined between a starting index and an ending index of the multimedia content based on the respective first and second parameter sets.

56. A system for dynamically creating a sample of multimedia content for preview by a user of a mobile terminal, comprising:
means for accessing a first set of parameters associated with a size of a preview sample of the multimedia content and a second set of parameters associated with composition of the preview sample;
means for dynamically generating a customized preview sample of the multimedia content for the specific mobile terminal using the respective first and second parameter sets; and
means for transmitting the customized preview sample to the specific mobile terminal, whereby the customized preview sample can be played back at the specific mobile terminal.

57. The system of claim 56, wherein the first set of parameters comprises one or more of a maximum downloading time parameter, a maximum downloading cost parameter, and a bit rate value associated with transmission of the customized preview sample to the specific mobile terminal, and the second set of parameters comprises at least one or more of a composition rule associated with a composition of the customized preview sample and a parameter indicative of a multimedia capability of the specific mobile terminal.

58. The system of claim 56, wherein the means for generating the customized preview sample further comprises one or both of a means for dynamically extracting the customized preview sample having a particular length based on the respective first and second parameter sets and a means for dynamically extracting the customized preview sample defined between a starting index and an ending index of the multimedia content based on the respective first and second parameter sets.

59. The system of claim 56, wherein the means for generating the customized preview sample further comprises means for formatting the customized preview sample to comply with a format usable by the specific mobile terminal.

60. The system of claim 56, wherein the means for generating the customized preview sample further comprises means for packaging the customized preview sample with predetermined usage or distribution rules.
